(19) United States
(12) Patent Application Publication
(10) Pub. No.: US 2015/0113475 A1
(43) Pub. Date: Apr. 23, 2015

(54) METHOD AND DEVICE FOR PROVIDING AN IMAGE PREVIEW

(71) Applicant: Xiaomi Inc., Beijing (CN)

(72) Inventors: Fei Xu, Beijing (CN); Weixing Li, Beijing (CN); Yahui Wang, Beijing (CN)

(21) Appl. No.: 14/580,225

(22) Filed: Dec. 23, 2014

Related U.S. Application Data
(63) Continuation-in-part of application No. PCT/CN2013/081620, filed on Aug. 16, 2013.

(30) Foreign Application Priority Data
Aug. 16, 2012 (CN) 201210292419.X

(51) Int. Cl. G06F 3/0481; G06F 3/0488

(52) U.S. Cl. CPC G06F 3/0481; G06F 3/0488
USPC 715/798

(57) ABSTRACT

The present disclosure provides a method and device for providing an image preview to improve the effect and efficiency of previewing images. The method includes: receiving a sliding gesture from a user through an interface of displaying an image; providing an image preview within a first boundary of the image if the sliding gesture is received through a first region of the interface; and providing the image preview within a second boundary of the image if the sliding gesture is received through a second region of the interface.

### CROSS-REFERENCE TO RELATED APPLICATIONS

This application is a Continuation-In-Part Application of International Application No. PCT/CN2013/081620, filed on Aug. 16, 2013, which is based upon and claims priority to Chinese Patent Application No. CN201210292419.X, filed on Aug. 16, 2012, the entire contents of which are incorporated herein by reference.

### TECHNICAL FIELD

The present disclosure generally relates to the technical field of computer and image processing, and more particularly, to a method and device for providing an image preview.

### BACKGROUND

With the rapid development of electronic technology, mobile phones, laptops, tablets and other electronic products have become popularized. Among them, electronic products with touch screens are receiving great attention, and are becoming mainstream products. As various new electronic products being continuously launched, various value-adding services attached to the electronic products become increasingly versatile and personalized. Aesthetic and personalized wallpaper is an indispensible service attached to the electronic products.

Before wallpaper is applied, a preview of the wallpaper has become a necessary application. In order to provide an excellent display effect of the wallpaper, a size of existing wallpaper in maximum resolution tends to be larger than a size of a display screen or a preview interface. A user may need to zoom out the wallpaper or move the wallpaper to preview the overall wallpaper.

### SUMMARY

Embodiments of the present disclosure provide a method and device for providing an image preview, so as to improve the effect and efficiency of previewing images.

In an aspect, the present disclosure provides a method for providing an image preview, including: receiving a sliding gesture from a user through an interface of displaying an image; providing an image preview within a first boundary of the image if the sliding gesture is received through a first region of the interface; and providing the image preview within a second boundary of the image if the sliding gesture is received through a second region of the interface.

In another aspect, the present disclosure provides a method for providing an image preview, including: receiving a sliding gesture from a user through an interface of displaying a wallpaper; displaying the wallpaper in maximum resolution if the sliding gesture is sliding movement with two fingers sliding outward; and displaying the wallpaper within a boundary of the interface if the sliding gesture is sliding movement with two fingers sliding inward.

In still another aspect, the present disclosure provides a device for providing an image preview, including: a processor; and a memory for storing instructions executable by the processor, wherein the processor is configured to perform: receiving a sliding gesture from a user through an interface of displaying an image; providing an image preview within a first boundary of the image if the sliding gesture is received through a first region of the interface; and providing the image preview within a second boundary of the image if the sliding gesture is received through a second region of the interface.

Other features and advantages of the disclosure will be set forth in the along with specification. Moreover, it will become apparent partly from the specification, or be understood by implementing the disclosure. The objects and other advantages of the disclosure may be realized and achieved by structures specially specified in the written specification, the claims and the accompanied drawings.

Hereinafter, a further detailed description will be given to the technical solution oft the disclosure in reference to the accompanied drawings and the embodiments.

### BRIEF DESCRIPTION OF THE DRAWINGS

The accompanying drawings are used for further illustrating the embodiments of the disclosure, and constitute a part of this specification, and together with the embodiments of the disclosure, serve to explain the present disclosure while do not limit the embodiments of the disclosure.

FIG. 1 is a schematic view showing an image in maximum resolution according to embodiments of the present disclosure;

FIG. 2 is a flow chart of a method for providing an image preview according to embodiments of the present disclosure;

FIG. 3 is a flow chart of a method for providing an image preview, in case where a first region is a preset region in a preview interface, and a second region comprises any other region of the preview interface except the first region, according to embodiments of the present disclosure;

FIG. 4 is a schematic view showing the first and second region and each boundary in an image according to embodiments of the present disclosure;

FIGS. 5 and 6 are schematic views showing a wallpaper being dragged to the left or right in the first region according to embodiments of the present disclosure;

FIGS. 7 and 8 are schematic views showing a wallpaper being dragged to the left or right in the second region according to embodiments of the present disclosure;

FIG. 9 is a flow chart of a method for providing an image preview, in case where the second region is a preset region in a preview interface, and the first region comprises any other region of the preview interface except the second region, according to embodiments of the present disclosure;

FIG. 10A is a flow chart of a method for providing a wallpaper preview according to embodiments of the present disclosure;

FIGS. 10B and 10C are schematic views respectively showing a wallpaper that have been zoomed in or zoomed out according to embodiments of the present disclosure;

FIG. 11 is a block diagram showing an apparatus according to embodiments of the present disclosure;

FIG. 12 is a block diagram showing another apparatus according to embodiments of the present disclosure; and

FIG. 13 is a block diagram of a device for providing an image preview according to embodiments of the present disclosure.

### DETAILED DESCRIPTION

Hereinafter, preferred embodiments of the disclosure will be described in reference to the accompanying drawings. It should be understood that the preferred embodiments described herein are used merely to illustrate and explain rather than to limit the embodiments of the disclosure.

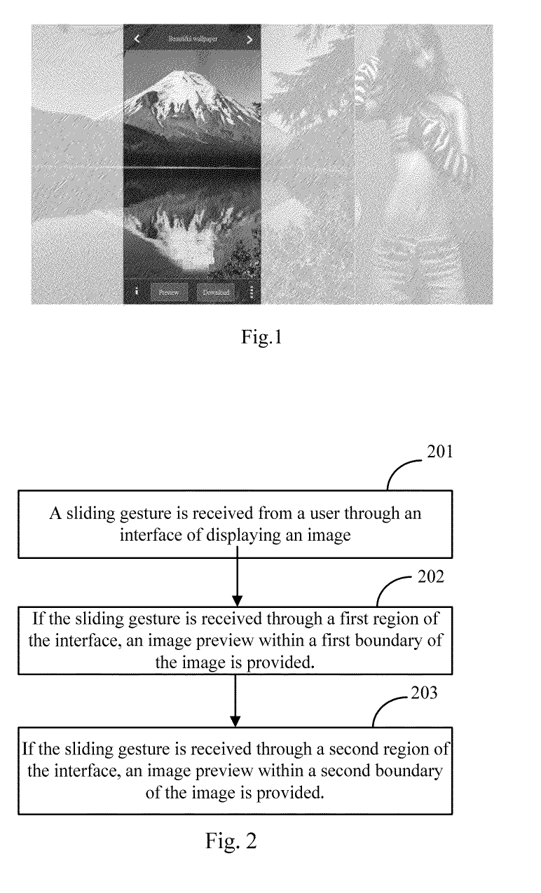

As shown in FIG. 1, if the user wishes to preview an image (such as a wallpaper) in maximum resolution, the user needs to move the current image from a current position to a boundary with respect to the next image, before the next image is previewed. Accordingly, the embodiments provide two kinds of choices for previewing an image. In the first choice, it is convenient for a user to preview an overall wallpaper within a first boundary. In the second choice, the user may quickly preview continuously switched wallpapers within a second boundary. Accordingly, the preview effect and processing efficiency of the image will be improved.

Referring to FIG. 2, a method for providing an image preview according to the embodiments includes the following steps.

In step 201, a sliding gesture is received from a user through an interface of displaying an image.

For example, the sliding gesture is received in a wallpaper preview application and the image is to be used as wallpaper. In the wallpaper preview application of a device (such as a mobile phone), one image to be used as wallpaper is displayed in the interface of the device, which can also be called as a preview interface. The device may be configured to have a touch screen or sensor to receive any gesture acted by the user. In the present invention, the sliding gesture from the user is received by the device through the interface in step 201.

In step 202, the device determines which part of the interface the sliding gesture is acted on. If it determines the sliding gesture is received through a first region of the interface, an image preview within a first boundary of the image is provided.

Otherwise, an image preview within a second boundary of the image is provided. In other words, in step 203, if the device determines the sliding gesture is received through a second region of the interface, an image preview within a second boundary of the image is provided.

For example, the sliding gesture acted on the first region represents an instruction of previewing of an overall wallpaper. Accordingly, the first boundary is an actual boundary when the wallpaper is displayed in maximum resolution. For example, the maximum resolution of the wallpaper (such as 1920*1080 pixels) is usually two times of the resolution of the screen of the device (such as 1920*2160 pixels), therefore the width of the first boundary is about two times of the width of the screen of the device. In other words, if the sliding gesture is acted on the first region of the interface, the wallpapers will be previewed in an overall mode to show all parts of the wallpaper to the user.

Moreover, the sliding gesture acted on the second region represents an instruction of continuously previewing of the wallpapers. Accordingly, the second boundary is a boundary of the interface of the device. For example, although the maximum resolution of the wallpaper (such as 1920*1080 pixels) is usually two times of the resolution of the screen of the device (such as 1920*2160 pixels), the width of the second boundary is as same as the width of the screen of the device. In other words, if the sliding gesture is acted on the second region of the interface, the wallpaper will be previewed in a partial mode instead of the overall mode.

Moreover, the first region and the second region may be defined in various manners. For example, the first region is a preset region in the preview interface, and the second region is any other region of the preview interface except the first region. Alternatively, the second region is a preset region in the preview interface, and the first region is any other region of the preview interface except the second region.

In case where the first region is a preset region in the preview interface and the second region is any other region of the preview interface except the first region, the step of providing the image preview within the first boundary of the image includes: determining an actual sliding distance of the sliding gesture; calculating an wallpaper moving distance by using a ratio of a size of the first region to a size of the wallpaper; and providing the wallpaper preview within the first boundary of the wallpaper according to the wallpaper moving distance. Moreover, the step of providing the image preview within the second boundary of the image includes: determining an actual sliding distance of the sliding gesture; and providing the wallpaper preview within the second boundary of the wallpaper according to the actual sliding distance of the gesture. This is a preferred exemplary implementation, and the wallpaper may be previewed according to other ratios instead of the ratio of the size of the first region to the size of the wallpaper, or without any ratio, and various implementations all apply to the embodiments.

In case where the second region is a preset region in the preview interface and the first region is any other region of the preview interface except the second region, the step of providing the image preview within the first boundary of the image includes: determining an actual sliding distance of the sliding gesture; and providing the wallpaper preview within the first boundary of the wallpaper according to the actual sliding distance of the gesture. Moreover, the step of providing the image preview within the second boundary of the image includes: providing the wallpaper preview within the second boundary of the wallpaper according to the sliding gesture. This is a preferred implementation, and the wallpaper may be previewed according to other distances, and various implementations are adapted to the embodiments.

Hereinafter, the implementation is described in detail with two typical embodiments.

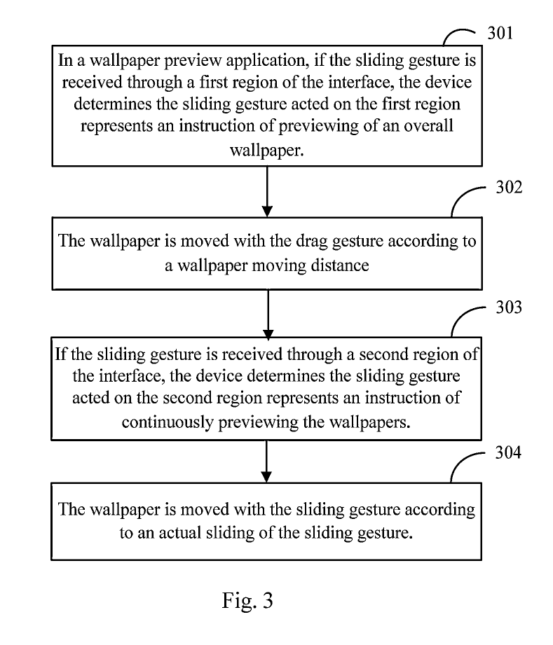

Referring to FIG. 3, in case where the first region is a preset region in the preview interface and the second region is any other region of the preview interface except the first region, the method for providing an image preview includes the following steps.

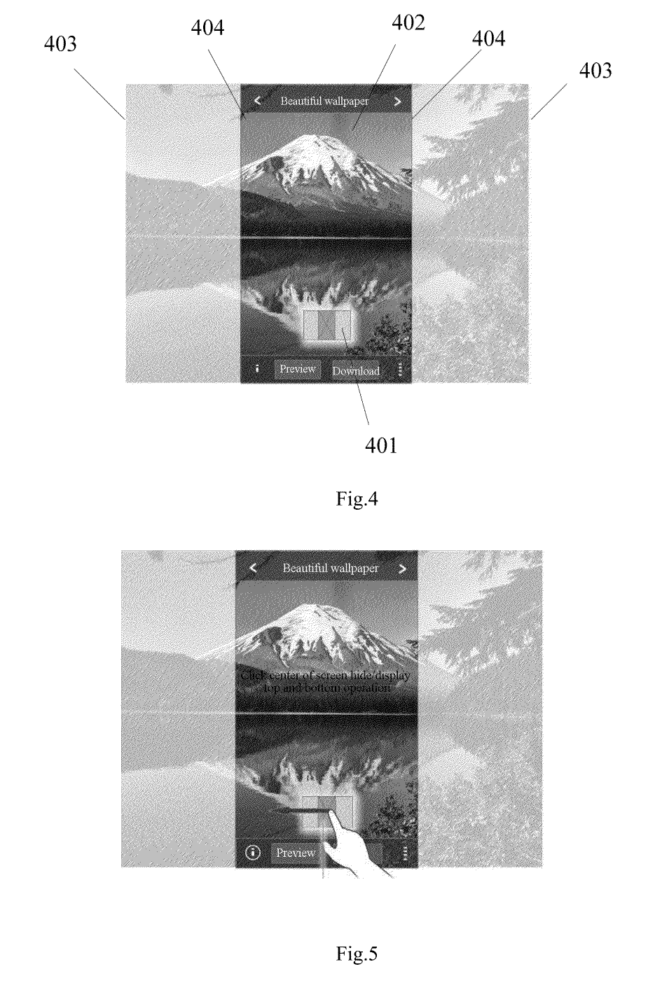

For example, as shown in FIG. 4, the first region is a region indicated as 401, the second region is a region indicated as the reference number 402, 403 indicates the first boundary, and the reference number 404 indicates the second boundary. Referring to FIG. 4, the first region 401 is displayed as a rectangle shape region with a sliding bar in the middle. The second region 402 is any other region of the interface except the rectangle shape region. The first boundary 403 represents the boundary of the whole wallpaper image, which is shown as the opaque parts in FIG. 4. The second boundary 404 represents the boundary of the interface, which is shown as the non-opaque parts in FIG. 4. In one exemplary embodiment, the width of the first boundary is about two times of the width of the interface.

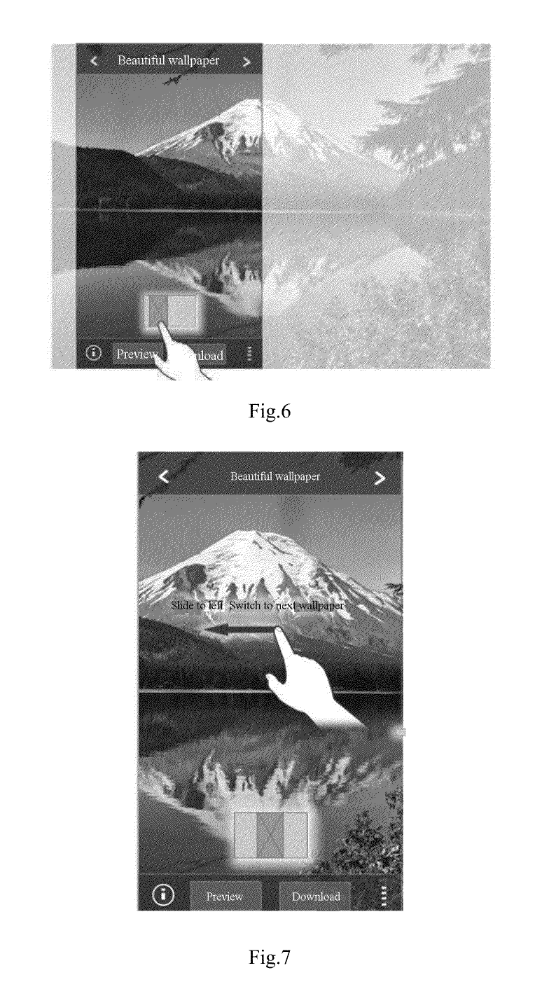

In step 301, in a wallpaper preview application, if the sliding gesture is received through a first region of the interface, the device determines the sliding gesture acted on the first region represents an instruction of previewing of an overall wallpaper. For example, the sliding gesture can be implemented by a drag gesture of the sliding bar in the first region to the left or a drag gesture of the sliding bar to the right, as shown in FIGS. 5 and 6.

In step 302, the wallpaper is moved with the drag gesture according to a wallpaper moving distance. In this case, the wallpaper moving distance is calculated by using the actual sliding distance of the drag gesture and the ratio of the size of the first region to the size of the wallpaper. Moreover, the moving range of the wallpaper is within the first boundary, that is, the actual boundary of the wallpaper displayed in maximum resolution. For example, as shown in FIG. 6, when the sliding bar of the first region is dragged from the middle to the left with a sliding distance of about ⅕ of the width of the first region, the wallpaper will be moved with the movement of the sliding bar with a moving distance of about ⅕ of the width of the wallpaper.

The sliding gesture acted on the first region may be continuously implemented. The displayed wallpaper is moved with each gesture.

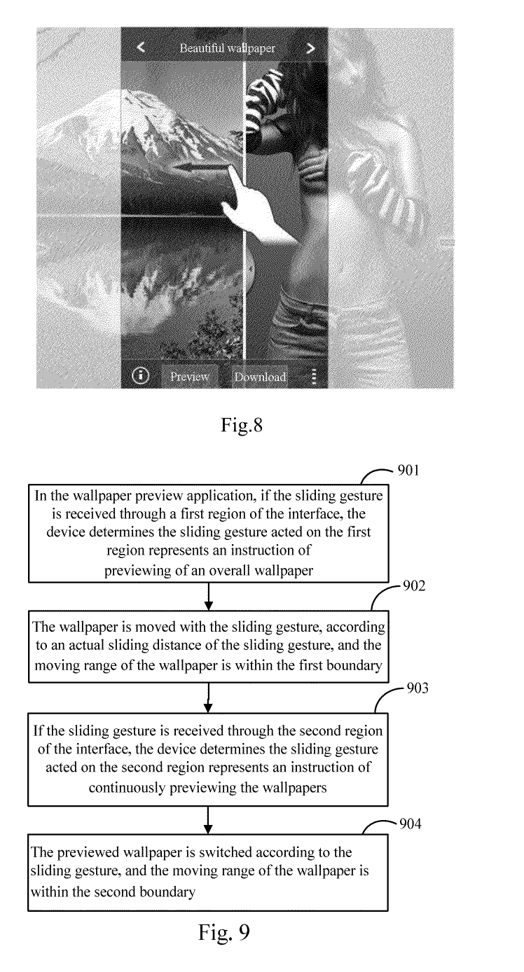

In step 303, in a wallpaper preview application, if the sliding gesture is received through a second region of the interface, the device determines the sliding gesture acted on the second region represents an instruction of continuously previewing the wallpapers. For example, the sliding gesture can be implemented by a sliding gesture in the second region to the left or a sliding gesture to the right, as shown in FIGS. 7 and 8.

In step 304, the wallpaper is moved with the sliding gesture according to an actual sliding of the sliding gesture. Moreover, the moving range of the wallpaper is within the second boundary. For example, as shown in FIG. 8, when the finger of the user slides from the middle to the left with a sliding distance of about 0.5 cm, the wallpaper will be moved with a moving distance of 0.5 cm within the second boundary of the wallpaper. Since the width of the second boundary is as same as the width of the interface, the sliding gesture will switch another wallpaper image into the interface.

The sliding gesture acted on the second region may also be continuously implemented. The displayed wallpaper is switched with each gesture. Moreover, each adjacent wallpaper shares the same second boundary, and the display is moved from the current wallpaper to the next wallpaper.

Referring to FIG. 9, in this embodiment, in case where the second region is a preset region in the preview interface and the first region is any other region of the preview interface except the second region, the method for providing an image preview includes the following steps.

In step 901, in the wallpaper preview application, if the sliding gesture is received through a first region of the interface, the device determines the sliding gesture acted on the first region represents an instruction of previewing of an overall wallpaper.

In step 902, the wallpaper is moved with the sliding gesture, according to an actual sliding distance of the sliding gesture, and the moving range of the wallpaper is within the first boundary, that is, the actual boundary of the wallpaper displayed in the maximum resolution.

The sliding gesture acted on the first region may be continuously implemented. The displayed wallpaper is moved with each gesture.

In step 903, in the wallpaper preview application, if the sliding gesture is received through the second region of the interface, the device determines the sliding gesture acted on the second region represents an instruction of continuously previewing the wallpapers.

In step 904, the previewed wallpaper is switched according to the sliding gesture, and the moving range of the wallpaper is within the second boundary.

The gesture instruction is the sliding gesture instruction in the second region, and is a single triggered instruction. Upon triggered, the display is moved from the current wallpaper to the next wallpaper, and each adjacent wallpaper shares the same second boundary.

The above embodiments mainly apply to preview of homepage wallpaper, and for preview of lock screen wallpaper, only the second boundary is adopted.

In addition, currently, zooming in or zooming out of an image is controlled by simultaneously sliding two fingers on two points of a touch screen, and the ratio of zoom is in accordance with the moving distance between the two points. Thus, zooming of the image may be operated several times. Particularly, in a wallpaper preview application, given that the size of the previewed wallpaper is usually of a maximum size or a minimum size, therefore the user may have to perform zooming of the image several times, which is inconvenient for the user.

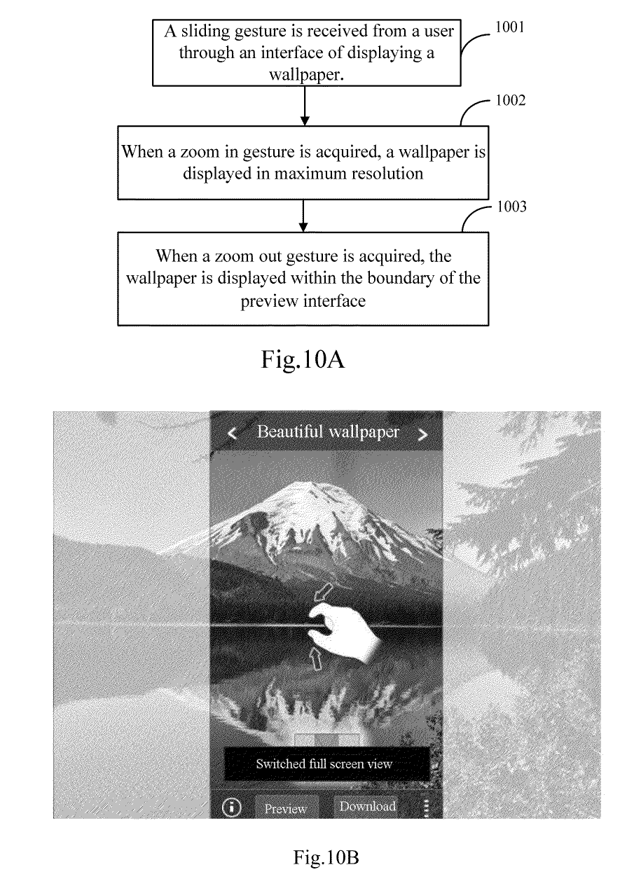

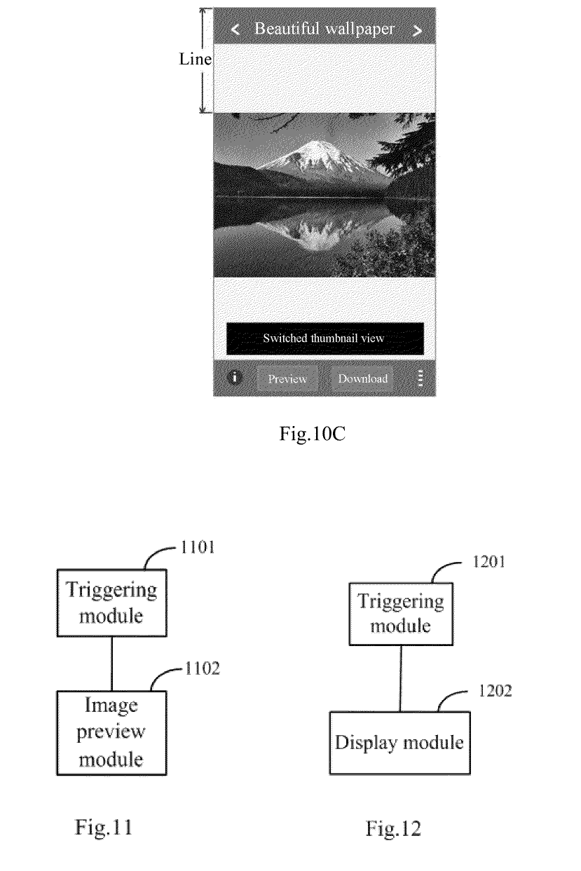

Referring to FIG. 10A, another method for providing a wallpaper preview includes the following steps.

In step 1001, a sliding gesture is received from a user through an interface of displaying a wallpaper in a wallpaper preview application.

In step 1002, when a zoom in gesture is acquired, the wallpaper is displayed in maximum resolution; wherein, the zoom in gesture is a sliding movement of two fingers sliding outward.

In step 1003, when a zoom out gesture is acquired, the wallpaper is displayed within the boundary of the preview interface; wherein, the zoom out gesture is a sliding movement of two fingers sliding inward. For example, a width of the wallpaper, which has been zoomed out corresponds to a width of the preview interface. In addition, while the zoom out gesture occurs, the displayed wallpaper is zoomed out in proportion to the sliding inward distance of the sliding gesture, and when the zoom out gesture is finished, the wallpaper is displayed within the boundary of the preview interface.

FIG. 10B is a schematic view showing the wallpaper that have been zoomed in, and FIG. 10C is a schematic view showing the wallpaper that have been zoomed out.

The above are implementation of a method for providing an image preview, which may be implemented with an apparatus. Hereinafter, an internal structure and functions of the apparatus are described.

Referring to FIG. 11, an apparatus for providing an image preview includes: a triggering module 1101 and a display module 1102.

The triggering module 1101 is configured to receive a sliding gesture from a user through an interface of displaying an image.

The image preview module 1102 is configured to provide an image preview within a first boundary of the image if the sliding gesture is received through a first region of the interface; and provide the image preview within a second boundary of the image if the sliding gesture is received through a second region of the interface.

For example, the sliding gesture is received in a wallpaper preview application and the image is to be used as wallpaper. Moreover, the sliding gesture acted on the first region represents an instruction of previewing of an overall wallpaper. Accordingly, the first boundary is an actual boundary when the wallpaper is displayed in maximum resolution. While the sliding gesture acted on the second region represents an instruction of continuously previewing of the wallpapers. Accordingly, the second boundary is a boundary of the interface of the device.

The first region is a preset region in the preview interface, and the second region is any other region of the preview interface except the first region. In this case, the image preview module 1102 is configured to determine an actual sliding distance of the sliding gesture; calculate an wallpaper moving distance by using a ratio of a size of the first region to a size of the wallpaper; and provide the wallpaper preview within the first boundary of the wallpaper according to the wallpaper moving distance. Moreover, the image preview module 1102 is further configured to determine an actual sliding distance of the sliding gesture; and provide the wallpaper preview within the second boundary of the wallpaper according to the actual sliding distance of the gesture.

The second region is a preset region in the preview interface, and the first region is any other region of the preview interface except the second region. In this case, the image preview module 1102 is configured to determine an actual sliding distance of the sliding gesture; and provide the wallpaper preview within the first boundary of the wallpaper according to the actual sliding distance of the gesture. Moreover, the image preview module 1102 is further configured to provide the wallpaper preview within the second boundary of the wallpaper according to the sliding gesture.

Referring to FIG. 12, an apparatus for providing a wallpaper preview includes: a triggering module 1201 and a display module 1202.

The triggering module 1201 is configured to, in a wallpaper preview application, receive a sliding gesture from a user through an interface of displaying a wallpaper.

The display module 1202 is configured to display the wallpaper in maximum resolution if the sliding gesture is sliding movement with two fingers sliding outward; and display the wallpaper within a boundary of the interface if the sliding gesture is sliding movement with two fingers sliding inward.

For example, the display module 1202 is configured to zoom out the wallpaper in proportion to the sliding distance of the gesture when the zoom out gesture occurs, and when the zoom out gesture is finished, display the wallpaper within the boundary of the preview interface.

In the embodiments, the triggering module 1101 and the triggering module 1201 may be included in a same module. The image preview module 1102 and the display module 1202 may be included in a same module.

The embodiments of the present disclosure provide two types of boundaries. Within a first boundary, it is convenient to implement preview of the overall wallpaper, and within a second boundary, continuous preview of wallpaper may be quickly performed, thereby improving the display effect and processing efficiency of an image. Moreover, the embodiments of the present disclosure provide more than one type of display regions, i.e. the first display region and the second region, thereby providing better processing method for different display regions, and further improving the display effect and processing efficiency of an image.

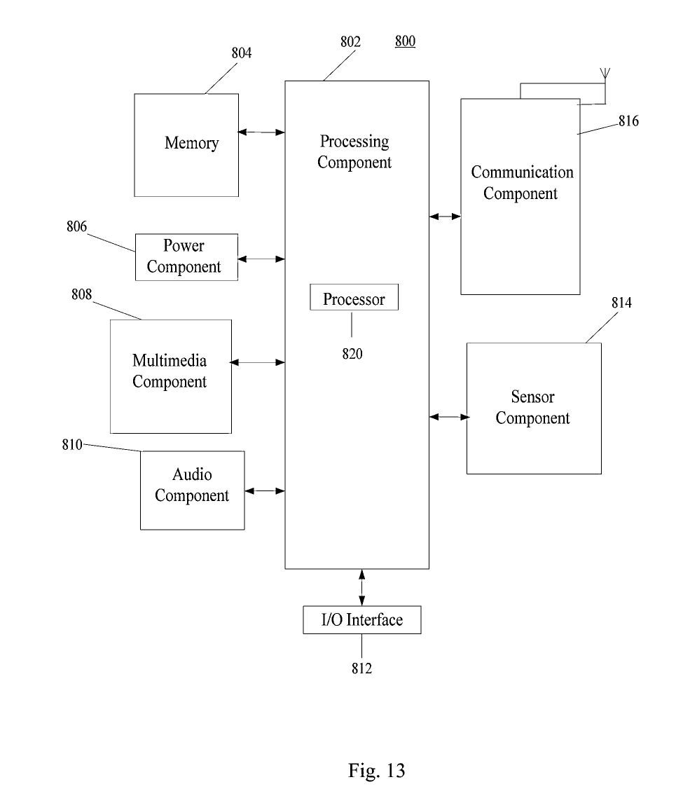

FIG. 13 is a block diagram of a device 800 for providing an image preview according to an exemplary embodiment. For example, the device 800 may be a mobile phone, a computer, a digital broadcast terminal, a messaging device, a gaming console, a tablet, a medical device, exercise equipment, a personal digital assistant, and the like.

Referring to FIG. 13, the device 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 800. For example, in the present disclosure, the memory 804 is configured to store data such as carious types of images, some of the images will be used as wallpaper. Examples of such data further include instructions for any applications or methods operated on the device 800, contact data, phonebook data, messages, images, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the device 800. The power component 806 may include a power management system, one or more power sources, and any other components associated with the generation, management, and distribution of power in the device 800.

The multimedia component 808 includes a screen providing an output interface between the device 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. For example, in the present disclosure, the touch screen or touch sensor is configured to receive the sliding gesture from a user through the interface of displaying the image. Accordingly, the processor is configured to provide an image preview with a first boundary of the image if the sliding gesture is received through a first region of the interface; and provide the image preview with a second boundary of the image if the sliding gesture is received through a second region of the interface. Moreover, the processor may be further configured to display the wallpaper in maximum resolution if the sliding gesture is sliding movement with two fingers sliding outward; and display the wallpaper within a boundary of the interface if the sliding gesture is sliding movement with two fingers sliding inward.

In some embodiments, the multimedia component 808 includes a front camera and/or a rear camera. The front camera and the rear camera may receive an external multimedia datum while the device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the device 800. For instance, the sensor component 814 may detect an open/closed status of the device 800, relative positioning of components, e.g., the display and the keypad, of the device 800, a change in position of the device 800 or a component of the device 800, a presence or absence of user contact with the device 800, an orientation or an acceleration/deceleration of the device 800, and a change in temperature of the device 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the device 800 and other devices. The device 800 can access a wireless network based on a communication standard, such as WiFi, 2G, or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 804, executable by the processor 820 in the device 800, for performing the above-described methods. For example, the non-transitory computer-readable storage medium may be a ROM, a RAM, a CD-ROM, a magnetic tape, a floppy disc, an optical data storage device, and the like.

It should be understood by those skilled in the art, that the embodiments of this disclosure may be provided as methods, systems or computer program products. Therefore, the disclosure may be implemented in forms of hardware only, software only, or a combination of software and hardware. Furthermore, the disclosure may be implemented in forms of computer program products executed on one or more computer usable storage media (including but not being limited to disk storage and optical storage, etc.) containing computer usable program codes.

The disclosure is described with reference to the method, the device (system) and the flowchart and/or a block diagram of a computer program product according to the embodiments of the disclosure. It should be understood that each process and/or block in the flowcharts and/or block diagrams, and combinations of processes and/or blocks in the flowcharts and/or block diagrams, may be implemented as computer program instructions. These computer program instructions may be provided to a generate-purpose computer, a special-purpose computer, an embedded processor, or processors of other programmable data processing devices, to produce a machine, such that a device for realizing functions designated in one or more processes in the flowcharts and/or in one or more blocks in the block diagrams, may be produced by instructions executed by a computer or processors of other programmable data processing devices.

These computer program instructions may further be stored in a computer readable storage that can boot a computer or other programmable data processing devices to operate in a specific way, such that a manufactured goods comprising an instruction device may be produced by the instructions stored in the said computer readable storage, and the said instruction device implements the functions designated in one or more processes in the flowcharts and/or in one or more blocks in the block diagrams.

These computer program instructions may further be loaded into a computer or other programmable data processing devices, such that a series of operating steps may be performed on the computer or other programmable data processing devices, so as to generate processes implemented by the computer, such that steps for realizing the functions designated in one or more processes in the flowcharts and/or in one or more blocks in the block diagrams may be provided by the instructions executed on the computer or other programmable data processing devices.

Apparently, those skilled in the art may make various modifications and variations to the disclosure without departing the intent and scope of the disclosure. Thus, the disclosure intends to include these modifications and variations if they belong to the scope of the claims of the disclosure and the equivalent technology thereof.

What is claimed is:

1. A method for providing an image preview, comprising:
receiving a sliding gesture from a user through an interface of displaying an image;
providing an image preview within a first boundary of the image if the sliding gesture is received through a first region of the interface; and
providing the image preview within a second boundary of the image if the sliding gesture is received through a second region of the interface.

2. The method of claim 1, wherein the sliding gesture is received in a wallpaper preview application and the image is to be used as wallpaper.

3. The method of claim 2, wherein the first boundary represents an actual boundary of the wallpaper when displayed in maximum resolutions and the second boundary represents a boundary of the interface.

4. The method of claim 1, wherein the first region is a preset region in the interface, and the second region comprises any other region of the interface except the first region.

5. The method of claim 4, wherein providing the image preview within the first boundary of the image comprises:
determining an actual sliding distance of the sliding gesture;
calculating an wallpaper moving distance by using a ratio of a size of the first region to a size of the wallpaper; and
providing the wallpaper preview within the first boundary of the wallpaper according to the wallpaper moving distance.

6. The method of claim 4, wherein providing the image preview within the second boundary of the image comprises:
determining an actual sliding distance of the sliding gesture; and
providing the wallpaper preview within the second boundary of the wallpaper according to the actual sliding distance of the gesture.

7. The method of claim 1, wherein the second region is a preset region in the interface, and the first region comprises any other region of the interface except the second region.

8. The method of claim 7, wherein providing the image preview within the first boundary of the image comprises:
determining an actual sliding distance of the sliding gesture; and
providing the wallpaper preview within the first boundary of the wallpaper according to the actual sliding distance of the gesture.

9. The method of claim 7, wherein providing the image preview within the second boundary of the image comprises:
providing the wallpaper preview within the second boundary of the wallpaper according to the sliding gesture.

10. A method for providing a wallpaper preview, comprising:
receiving a sliding gesture from a user through an interface of displaying a wallpaper;
displaying the wallpaper in maximum resolution if the sliding gesture is sliding movement with two fingers sliding outward; and
displaying the wallpaper within a boundary of the interface if the sliding gesture is sliding movement with two fingers sliding inward.

11. The method of claim 10, wherein displaying the wallpaper within the boundary of the interface comprises:
zooming out the wallpaper in proportion to a sliding inward distance of the sliding gesture; and
displaying the wallpaper within the boundary of the interface when the sliding gesture is finished.

12. A device for providing an image preview, comprising:
a processor; and
a memory for storing instructions executable by the processor,
wherein the processor is configured to perform:
receiving a sliding gesture from a user through an interface of displaying an image;
providing an image preview within a first boundary of the image if the sliding gesture is received through a first region of the interface; and
providing the image preview within a second boundary of the image if the sliding gesture is received through a second region of the interface.

13. The device of claim 12, wherein the sliding gesture is received in a wallpaper preview application and the image is to be used as wallpaper.

14. The device of claim 13, wherein the first boundary represents an actual boundary of the wallpaper when displayed in maximum resolutions and the second boundary represents a boundary of the interface.

15. The device of claim 12, wherein the first region is a preset region in the interface, and the second region comprises any other region of the interface except the first region.

16. The device of claim 15, wherein providing the image preview within the first boundary of the image comprises:
determining an actual sliding distance of the sliding gesture;
calculating an wallpaper moving distance by using a ratio of a size of the first region to a size of the wallpaper; and
providing the wallpaper preview within the first boundary of the wallpaper according to the wallpaper moving distance.

17. The device of claim 15, wherein providing the image preview within the second boundary of the image comprises:
determining an actual sliding distance of the sliding gesture; and
providing the wallpaper preview within the second boundary of the wallpaper according to the actual sliding distance of the gesture.

18. The device of claim 12, wherein the second region is a preset region in the interface, and the first region comprises any other region of the interface except the second region.

19. The device of claim 18, wherein providing the image preview within the first boundary of the image comprises:
determining an actual sliding distance of the sliding gesture; and
providing the wallpaper preview within the first boundary of the wallpaper according to the actual sliding distance of the gesture.

20. The device of claim 18, wherein providing the image preview within the second boundary of the image comprises:
providing the wallpaper preview within the second boundary of the wallpaper according to the sliding gesture.
